(19) United States
(12) Patent Application Publication
(10) Pub. No.: US 2024/0283166 A1
(43) Pub. Date: Aug. 22, 2024

(54) ANTENNA STRUCTURE AND IMAGE DISPLAY DEVICE INCLUDING THE SAME

(71) Applicant: DONGWOO FINE-CHEM CO., LTD., Jeollabuk-do (KR)

(72) Inventors: KI HUN SUNG, Jeollabuk-do (KR); SUNG JOON HONG, Jeollabuk-do (KR); DAE KYU KIM, Jeollabuk-do (KR); HEE JUN PARK, Jeollabuk-do (KR); MEE AE HUR, Jeollabuk-do (KR)

(21) Appl. No.: 18/582,779

(22) Filed: Feb. 21, 2024

(30) Foreign Application Priority Data
Feb. 21, 2023 (KR) 10-2023-0022558

(51) Int. Cl. H01Q 21/06; G01S 13/62; H01Q 1/22; H01Q 9/04

(52) U.S. Cl. CPC H01Q 21/065; G01S 13/62; H01Q 1/22; H01Q 9/0407

(57) ABSTRACT

An antenna structure may include a transmission antenna unit group, and a reception antenna unit group spaced apart from the transmission antenna unit group in a first direction. The transmission antenna unit group includes a first transmission antenna unit, and a second transmission antenna unit having a length in a second direction greater than a length of the first transmission antenna unit in the second direction, the second direction being perpendicular to the first direction. The reception antenna unit group includes a first reception antenna unit spaced apart from the first transmission antenna unit in the first direction and including a first reception radiator, and a second reception antenna unit including a second reception radiator spaced apart the first reception radiator in the second direction.

### CROSS-REFERENCE TO RELATED APPLICATION AND CLAIM OF PRIORITY

This application claims the benefit under 35 USC § 119 of Korean Patent Application No. 10-2023-0022558 filed on Feb. 21, 2023, in the Korean Intellectual Property Office, the entire disclosure of which is incorporated herein by reference for all purposes.

### BACKGROUND

### 1. Field

The present invention relates to an antenna structure and an image display device including the same.

### 2. Description of the Related Art

As information technologies have been developed, a wireless communication technology such as Wi-Fi, Bluetooth, etc., or a non-contact sensing such as a gesture detection and a motion recognition is being applied to or embedded in image display devices, electronic devices and architecture.

Additionally, with the development of mobile communication technology, an antenna for performing a communication in high-frequency or ultra-high frequency bands is being applied or embedded into various mobile devices, the Internet of Things (IOT), autonomous vehicles, etc.

For example, the wireless communication technology is being implemented and combined with an image display device in the form of a smartphone. Accordingly, the antenna may be coupled to the image display device to perform a communication function, an information transmission function, etc.

As the image display device on which the antenna is employed becomes thinner and lighter, a space occupied by the antenna may also decrease. Accordingly, the antenna may be included in the form of a film or patch on the display panel so as to insert the antenna in a limited space.

However, the antenna capable of implementing high-precision sensing performance such as motion recognition, distance measurement, position detection, etc., may not be implemented in the limited space.

### SUMMARY

According to an aspect of the present invention, there is provided an antenna structure having improved sensitivity.

According to an aspect of the present invention, there is provided a motion sensor including the antenna structure.

According to an aspect of the present invention, there is provided a radar sensor including the antenna structure.

According to an aspect of the present invention, there is provided an image display device including the antenna structure.

(1) An antenna structure, including: a transmission antenna unit group; and a reception antenna unit group spaced apart from the transmission antenna unit group in a first direction,
wherein the transmission antenna unit group includes: a first transmission antenna unit; and a second transmission antenna unit having a length in a second direction greater than a length of the first transmission antenna unit in the second direction, the second direction being perpendicular to the first direction,
wherein the reception antenna unit group includes: a first reception antenna unit spaced apart from the first transmission antenna unit in the first direction, the first reception antenna unit including a first reception radiator; and a second reception antenna unit including a second reception radiator spaced apart the first reception radiator in the second direction.

(2) The antenna structure according to the above (1), wherein the second transmission antenna unit is spaced apart from the reception antenna unit group in the first direction with the first transmission antenna unit interposed therebetween.

(3) The antenna structure according to the above (1), wherein the first transmission antenna unit includes a first transmission radiator, a first transmission transmitting line connected to the first transmission radiator, and a first transmission sub-ground disposed around the first transmission transmitting line; and the second transmission antenna unit includes a second transmission radiator, a second transmission transmitting line connected to the second transmission radiator, and a second transmission sub-ground disposed around the second transmission transmitting line.

(4) The antenna structure according to the above (3), wherein a spacing distance between the first transmission radiator and the second transmission radiator in the first direction is in a range from 80% to 150% of a half-wavelength (Ξ/2) of a maximum resonance frequency, and a spacing distance between the first transmission radiator and the second transmission radiator in the second direction is in a range from 80% to 150% of the half-wavelength (Ξ/2) of the maximum resonance frequency.

(5) The antenna structure according to the above (3), wherein a length of the second transmission transmitting line in the second direction is greater than a length of the first transmission transmitting line in the second direction.

(6) The antenna structure according to the above (3), wherein a length of the second transmission sub-ground in the second direction is greater than a length of the first transmission sub-ground in the second direction.

(7) The antenna structure according to the above (3), wherein the first transmission antenna unit further includes a first transmission signal pad connected to one end portion of the first transmission transmitting line, and a first transmission ground pad disposed around the first transmission signal pad; and the second transmission antenna unit further includes a second transmission signal pad connected to one end portion of the second transmission transmitting line, and a second transmission ground pad disposed around the second transmission signal pad.

(8) The antenna structure according to the above (7), wherein a length of the first transmission sub-ground in the first direction is smaller than a length of the first transmission ground pad in the first direction.

(9) The antenna structure according to the above (1), wherein the first reception antenna unit includes a plurality of first reception antenna units arranged in a row along the first direction, and the second reception radiator is spaced apart from the first reception radiator included in at least one of the plurality of first reception antenna units in the second direction.

(10) The antenna structure according to the above (9), wherein the second reception radiator is spaced apart from the first reception radiator included in a first reception antenna unit farthest from the first transmission antenna unit among the plurality of first reception antenna units to face the first reception radiator in the second direction.

(11) The antenna structure according to the above (9), wherein a spacing distance between adjacent first reception radiators among the first reception radiators included in the plurality of first reception antenna units is in a range from 80% to 150% of a half-wavelength (Ξ/2) of a maximum resonance frequency.

(12) The antenna structure according to the above (1), wherein a spacing distance between the second reception radiator and the first reception radiator adjacent to the second reception radiator is in a range from 80% to 150% of a half-wavelength (22) of a maximum resonance frequency.

(13) The antenna structure according to the above (1), wherein the first reception antenna unit further includes a first reception transmitting line connected to the first reception radiator and a first reception sub-ground disposed around the first reception transmitting line; and the second reception antenna unit further includes a second reception transmitting line connected to the second reception radiator and a second reception sub-ground disposed around the second reception transmitting line.

(14) The antenna structure according to the above (13), wherein the second reception transmitting line includes a bent portion where an extension direction of the second reception transmitting line is changed from the first direction to the second direction or from the second direction to the first direction.

(15) The antenna structure according to the above (13), wherein the first reception antenna unit further includes a first reception signal pad connected to one end portion of the first reception transmitting line, and a first reception ground pad disposed around the first reception signal pad; and the second reception antenna unit further includes a second reception signal pad connected to one end portion of the second reception transmitting line, and a second reception ground pad disposed around the second reception signal pad.

(16) The antenna structure according to the above (1), further including a dielectric layer on which the transmission antenna unit group and the reception antenna unit group are disposed, wherein the transmission antenna unit group and the reception antenna unit group are disposed at the same level on the dielectric layer.

(17) A motion recognition sensor including the antenna structure according to the above-described embodiments.

(18) A radar sensor including the antenna structure according to the above-described embodiments.

(19) An image display device, including a display panel; and the antenna structure according to the above-described embodiments disposed on the display panel.

In example embodiments, the antenna structure may include a transmission antenna unit group and a reception antenna unit group. The transmission antenna unit group may include a first transmission antenna unit and a second transmission antenna unit having a length larger than that of the first transmission antenna unit. A virtual radiator may be formed in the reception antenna unit group by the second transmission antenna unit. Accordingly, an angular resolution of a motion recognition from the antenna structure may be improved, and precision of motion tracking in azimuth and elevation angle directions may be enhanced.

In some embodiments, the reception antenna unit group may a plurality of first reception antenna units arranged in a first direction and a second reception antenna unit arranged in a second direction perpendicular to the first direction with respect to at least one of the first reception antenna units. Thus, signal intensities in two directions perpendicular to each other may be detected.

For example, each of the antenna units may include a radiator, a transmission line connected to the radiator, and a sub ground disposed around the transmission line. Accordingly, driving properties of the antenna unit may be improved, and radiation directivity and gain may be enhanced to improve signal sensitivity.

In some embodiments, the antenna structure may be electrically coupled to a motion sensor driving circuit or a radar processor through a circuit board. Accordingly, a signal change by a sensing target may be transmitted to the motion sensor driving circuit or the radar processor, and positions and distances in all directions may be measured based on the collected signal information.

### BRIEF DESCRIPTION OF THE DRAWINGS

FIG. 1 is a schematic plan view illustrating an antenna structure in accordance with exemplary embodiments.

FIG. 2 is a schematic plan view describing a formation of a virtual radiator.

FIG. 3 is a schematic plan view illustrating an antenna structure in accordance with exemplary embodiments.

FIG. 4 is a schematic plan view illustrating an antenna unit in accordance with exemplary embodiments.

FIG. 5 is a schematic plan view illustrating an antenna structure in accordance with exemplary embodiments.

FIGS. 6 and 7 are a schematic plan view and a cross-sectional view illustrating an image display device in accordance with exemplary embodiments.

### DETAILED DESCRIPTION OF THE EMBODIMENTS

According to exemplary embodiments of the present invention, an antenna structure including a plurality of antenna unit groups.

A motion recognition sensor, a radar and an image display device according to embodiments of the present invention may include the antenna structure. The antenna structure may be applied to various objects or structures such as a vehicle, a home electronic appliance, an architecture, etc.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “one end”, “other end”, “upper side”, “lower side”, etc., as used herein are not intended to limit an absolute position or order, but is used in a relative sense to distinguish different components or elements.

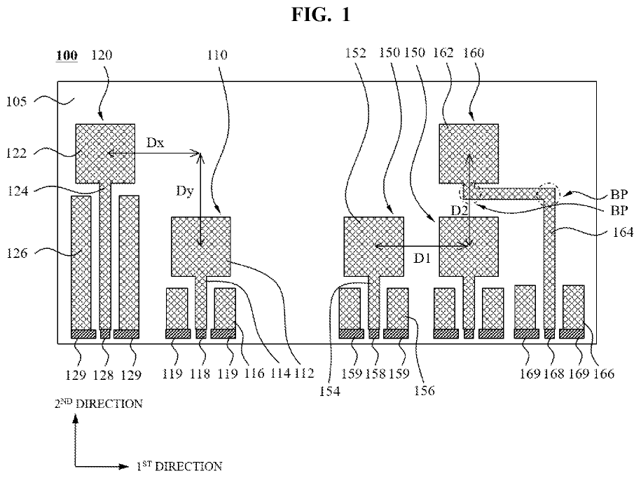

FIG. 1 is a schematic plan view illustrating an antenna structure in accordance with exemplary embodiments.

Referring to FIG. 1, the antenna structure 100 includes a transmission antenna unit group and a reception antenna unit group spaced apart from each other in a first direction.

For example, the antenna structure 100 may further include a dielectric layer 105 on which the transmission antenna unit group and the reception antenna unit group are arranged.

The first direction may be, e.g., a width direction of the dielectric layer 105 and/or the antenna structure 100.

The dielectric layer 105 may include, e.g., a transparent resin material. For example, the dielectric layer 105 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more thereof.

The dielectric layer 105 may include an adhesive material such as an optically clear adhesive (OCA), an optically clear resin (OCR), or the like. In some embodiments, the dielectric layer 105 may include an inorganic insulating material such as glass, silicon oxide, silicon nitride, silicon oxynitride, etc.

In an embodiment, the dielectric layer 105 may be provided as a substantially single layer.

In an embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

Capacitance or inductance for the antenna structure 100 may be formed by the dielectric layer 105, so that a frequency band at which the antenna structure may be driven or operated may be adjusted. In some embodiments, a dielectric constant of the dielectric layer 105 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer may be disposed on a bottom surface of the dielectric layer 105. Generation of an electric field in a transmission line may be more promoted by the ground layer, and an electrical noise around the transmission line may be absorbed or shielded.

In some embodiments, the ground layer may be included an individual member of the antenna structure 100. In some embodiments, a conductive member of an image display device to which the antenna structure 100 is applied may serve as the ground layer 90.

For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the display device such as a SUS plate, a sensor member such as a digitizer, a heat dissipation sheet, etc., may serve as the ground layer.

In example embodiments, the transmission antenna unit group includes a first transmission antenna unit 110 and a second transmission antenna unit 120.

For example, a length of the second transmission antenna unit 120 in a second direction perpendicular to the first direction may be greater than a length of the first transmission antenna unit 110 in the second direction. Accordingly, a virtual radiator of the reception antenna unit group may be formed.

The second direction may be, e.g., a length direction of the dielectric layer 105 and/or the antenna structure 100.

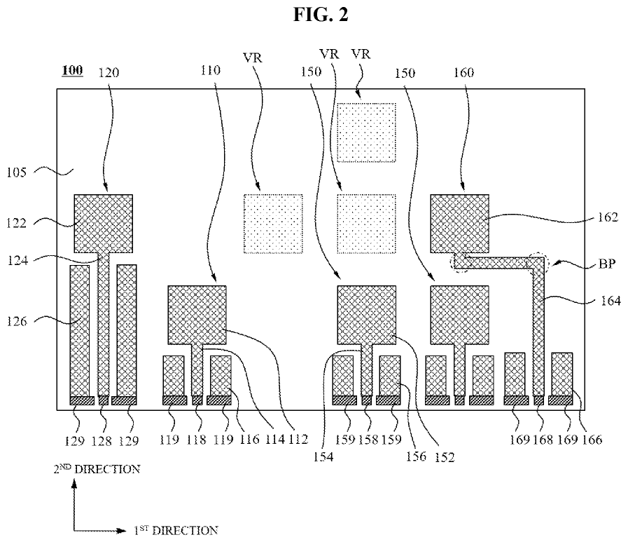

FIG. 2 is a schematic plan view describing a formation of a virtual radiator.

Referring to FIG. 2, a virtual radiator VR may be formed in the reception antenna unit group by the second transmission antenna unit 120. For example, the virtual radiator VR may indicate a virtual region which does not physically exist but may serve as a reception radiator.

For example, the virtual radiator VR may have the same shape, size, spacing distance between the radiators and arrangement as those of reception radiators 152 and 162 included in the reception antenna unit group.

For example, the spacing distance in the first and/or second directions between the adjacent virtual radiators VR and the reception radiators 152 and 162 may be substantially the same as the spacing distance in the first and/or second directions between transmission radiators 112 and 122.

For example, the formation position of the virtual radiator VR may be adjusted according to the spacing distance between the transmission radiators 112 and 122.

From the formation of the virtual radiator VR, substantially the same effect as that of disposing an additional reception radiator in the reception antenna unit group may be obtained. Accordingly, an angular resolution of motion recognition of the antenna structure 100 may be improved, and precision of a motion tracking in azimuth and elevation angle directions may be improved.

In some embodiments, the second transmission antenna unit 120 may be spaced apart from the reception antenna unit group in the first direction with the first transmission antenna unit 110 interposed therebetween. Accordingly, the virtual radiator VR may be formed without overlapping the reception radiators 152 and 162. Thus, sensing precision of the antenna structure 100 may be further improved.

Referring again to FIG. 1, the first transmission antenna unit 110 may include the first transmission radiator 112, a first transmission transmitting line 114 connected to the first transmission radiator 112, and a first transmission sub-ground 116 disposed around the first transmission transmitting line 114. The second transmission antenna unit 120 may include a second transmission radiator 122, a second transmission transmitting line 124 connected to the second transmission radiator 122, and a second transmission sub-ground 126 disposed around the second transmission transmitting line 124.

For example, the first transmission sub-ground 116 and the second transmission sub-ground 126 may be physically spaced apart from the first transmission transmitting line 114 and the second transmission transmitting line 124, respectively. In an embodiment, the first transmission sub-ground 116 and the second transmission sub-ground 126 may extend in parallel to an extension direction of the first transmission transmitting line 114 and the second transmission transmitting line 124, respectively.

In an embodiment, a pair of the first transmission sub-grounds 116 may be disposed to be spaced apart from each other with the first transmission transmitting line 114 interposed therebetween, and a pair of the second transmission sub-grounds 126 may be disposed to be spaced apart from each other with the second transmission transmitting 124 interposed therebetween. The transmission sub-grounds 116 and 126 may be disposed around the transmission transmitting lines 114 and 124, so that a gain and a beam width of the antenna structure 100 may be enhanced.

In example embodiments, signal interference and disturbance between a plurality of transmission antenna units 110 and 120 may be suppressed by the transmission sub-grounds 116 and 126. Thus, the gain of the antenna structure 100 may be improved, and noise generation may be suppressed.

In example embodiments, a strong electromagnetic field may be generated in a region between end portions of the transmission transmitting lines 114 and 124 (e.g., a bonding portion with a circuit board) and the transmission radiators 112 and 122, by the transmission sub-grounds 116 and 126. Thus, an electromagnetic field intensity in a direction toward the circuit board may be increased, so that a radiation directivity of the transmission antenna units 110 and 120 may be improved and the beam width may be expanded.

For example, an additional radiation or an auxiliary radiation may be provided by the transmission sub-grounds 116 and 126, and the antenna gain and radiation directivity (e.g., vertical radiation properties) may be improved. Therefore, even in an ultra-high frequency band of 50 GHz or more, the antenna structure 100 may have high signal efficiency and sensitivity, and accuracy of sensing performance may be improved.

In some embodiments, a length of the second transmission transmitting line 124 in the second direction may be greater than a length of the first transmission transmitting line 114 in the second direction. Accordingly, the second transmission radiator 122 and the first transmission radiator 112 may be spaced apart from each other in the second direction. Therefore, the virtual radiator of the reception antenna unit group may be formed.

In some embodiments, a length of the second transmission sub-ground 126 in the second direction may be greater than a length of the first transmission sub-ground 116 in the second direction. Accordingly, the above-described signal interference of the transmission antenna unit group may be further prevented.

In some embodiments, a spacing distance Dx between the first transmission radiator 112 and the second transmission radiator 122 in the first direction may be greater than or equal to 80% of a half wavelength (Ξ/2) of a maximum resonance frequency of the antenna structure 100. A spacing distance Dy between the first transmission radiator 112 and the second transmission radiator 122 in the second direction may be greater than or equal to 80% of a half wavelength (Ξ/2) of the maximum resonance frequency.

The term “spacing distance” used herein may refer to the shortest linear distance connecting central points of the radiators in a plan view.

The “spacing distance Dx between the first transmission radiator 112 and the second transmission radiator 122 in the first direction” may be the shortest distance from a point where a virtual line extending in the first direction from a central point of the second transmission radiator 112 meets a virtual line extending in the second direction from a central point of the first transmission radiator 122 to the central point of the second transmission radiator 122.

The “spacing distance (Dy) between the first transmission radiator 112 and the second transmission radiator 122 in the second direction” may be the shortest distance from a point where a virtual line extending from the central point of the second transmission radiator 122 in the first direction meets a virtual line extending the central point of the first transmission radiator 112 in the second direction to the central point of the first transmission radiator 112.

For example, the spacing distance Dx in the first direction and the spacing distance Dy in the second direction between the first transmission radiator 112 and the second transmission radiator 122 may each be 90% or more, 95% or more, or 100% or more of half a wavelength (Ξ/2) of the maximum resonance frequency.

For example, the spacing distance Dx in the first direction and the spacing distance Dy in the second direction between the first transmission radiator 112 and the second transmission radiator 122 may each be 150% or less, 120% or less, or 110% or less of half a wavelength (Ξ/2) of the maximum resonance frequency.

For example, the spacing distance Dx in the first direction and the spacing distance Dy in the second direction between the first transmission radiator 112 and the second transmission radiator 122 may each be in a range from 80% to 150% of half a wavelength (22) of the maximum resonance frequency.

In one embodiment, the spacing distance Dx in the first direction and the spacing distance Dy in the second direction between the first transmission radiator 112 and the second transmission radiator 122 may each be half a wavelength (Ξ/2) of the maximum resonance frequency.

Within the range of the spacing distance Dx and Dy, desired radiation properties may be achieved while preventing mutual interference between the first and second transmission antenna units 110 and 120. Thus, signal loss and distortion may be prevented, so that high sensitivity and accuracy may be implemented in, e.g., a motion detection or a distance detection.

For example, the spacing distance Dx in the first direction and the spacing distance Dy in the second direction between the first transmission radiator 112 and the second transmission radiator 122 may be changed, so that the spacing distance between the virtual radiator VR and the reception radiators 152 and 162 may be adjusted.

In some embodiments, the first transmission antenna unit 110 may include a first transmission signal pad 118 connected to one end portion of the first transmission transmitting line 114 and a first transmission ground pad 119 disposed around the first transmission signal pad 118. The second transmission antenna unit 120 may include a second transmission signal pad 128 connected to one end portion of the second transmission transmitting line 124 and a second transmission ground pad 129 disposed around the second transmission signal pad 128.

For example, the first transmission ground pad 119 and the second transmission ground pad 129 may be electrically and physically separated from the first transmission signal pad 118 and the second transmission signal pad 128, respectively.

In one embodiment, the first transmission antenna unit 110 may include a pair of the first transmission ground pads 119 spaced apart from each other with the first transmission signal pad 118 interposed therebetween. The second transmission antenna unit 120 may include a pair of the second transmission ground pads 129 spaced apart from each other with the second transmission signal pad 128 interposed therebetween.

For example, the first transmission signal pad 118 and the second transmission signal pad 128 may be provided as substantially integral members with the first transmission transmitting line 114 and the second transmission transmitting line 124, respectively. For example, a terminal end portion of the first transmission transmitting line 114 and a terminal end portion of the second transmission transmitting line 124 may be provided as the first transmission signal pad 118 and the second transmission signal pad 128, respectively.

For example, the first transmission sub-ground 116 and the second transmission sub-ground 126 may extend from the first transmission ground pad 119 and the second transmission ground pad 129, respectively.

In one embodiment, the first transmission sub-ground 116 and the second transmission sub-ground 126 may be formed as a single member integrally connected to the first transmission ground pad 119 and the second transmission ground pad 129, respectively. For example, the first transmission sub-ground 116 may extend from the first transmission ground pad 119 toward the first transmission radiator 112. For example, the second transmission sub-ground 126 may extend from the second transmission ground pad 129 toward the second transmission radiator 122.

In example embodiments, the reception antenna unit group may include a first reception antenna unit 150 being spaced apart from the first transmission antenna unit 110 in the first direction and including a first reception radiator 152. The reception antenna unit group may include a second reception antenna unit 160 including a second reception radiator 162 spaced apart from the first reception radiator 152 in the second direction.

For example, a distance between the reception antenna unit group and the transmission antenna unit group may be greater than or equal to a half-wavelength (Ξ/2) of the maximum resonance frequency.

For example, a spacing distance between the first transmission radiator 112 and the first reception radiator 152 in the first direction may be greater than or equal to the half-wavelength (22) of the maximum resonance frequency.

In one embodiment, the spacing distance between the first transmission radiator 112 and the first reception radiator 152 in the first direction may be 80% or more of the half-wavelength (22) of the maximum resonance frequency.

In some embodiments, the first reception antenna unit 150 may include a plurality of the first reception antenna units 150 arranged to be spaced apart in a single row along the first direction.

For example, the plurality of the first reception antenna units 150 may be arranged along a virtual axis (a first axis) that is parallel to the first direction and commonly passes through the central points of the first reception radiators 152.

For example, the second reception radiator 162 may be arranged to be spaced apart from the first reception radiator 152 included in at least one of the plurality of the first reception antenna units 150 in the second direction.

In one embodiment, the second reception radiator 162 may face the first reception radiator 152 included in the first reception antenna unit that is the farthest from the first transmission antenna unit 110 among the plurality of the first reception antenna units 150 in the second direction.

In one embodiment, the plurality of the first reception antenna units 150 may consist of two first reception antenna units.

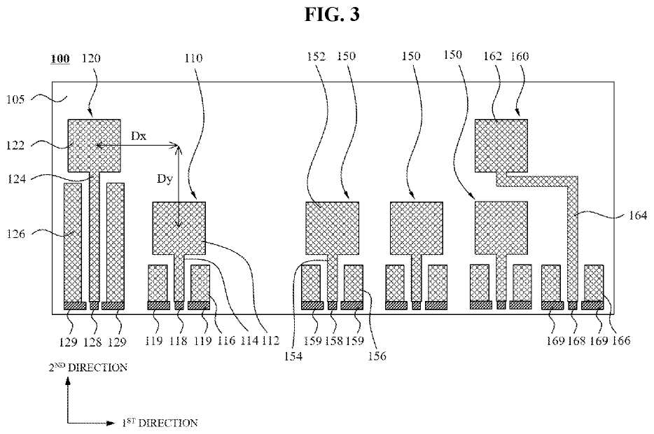

In one embodiment, the plurality of the first reception antenna units 150 may include three or more first reception antenna units (see FIG. 3). Accordingly, the angle resolution and precision of the reception antenna unit group may be improved.

For example, the first reception radiator 152 and the second reception radiator 162 may be arranged along a virtual axis (a second axis) parallel to the second direction and commonly passing through central points of the first reception radiator 152 and the second reception radiator 162.

For example, the first reception radiator 152 and the second reception radiator 162 may be driven independently from each other. Accordingly, signal intensities according to the position or distance of the sensing object in the first direction and the second direction may each be measured. Thus, a signal change in each direction over time may be measured so that an action and a moving distance of the sensing object may be sensed.

For example, the antenna structure 100 may detect signals in two orthogonal axes (the first axis and the second axis). For example, the antenna structure 100 may transmit signal intensity changes in two orthogonal directions to a motion sensor driving circuit or a radar processor. The driving circuit or the processor may measure position changes or distances in all directions on an X-Y coordinate system based on the collected information.

For example, the antenna structure may serve as a motion sensor capable of detecting a motion or a gesture on two axes perpendicular to each other, or may be used for a radar that detects a distance. The first reception antenna unit 150 and the second reception antenna unit 160 may serve as a reception radiation unit for the detection of the motion or the distance. For example, the first and second reception radiators 152 and 162 may receive a signal reflected from the sensing object.

For example, the first reception radiator 152 of the first reception antenna unit arranged in a region where the first axis and the second axis intersect among the plurality of the first reception antenna units 150 may serve as a reference point for measuring the signal intensity change. For example, a change in the position of the sensing object may be detected by measuring the signal intensity change in the first axis and the second axis based on the signal intensity of the first reception radiator 152 arranged at the intersection region.

In some embodiments, each of the transmission radiators 112 and 122 and the reception radiators 152 and 162 may be designed to have, e.g., a resonance frequency in a high frequency or ultra-high frequency band of 3G, 4G, 5G, or more. In an embodiment, the resonance frequency of each of the transmission radiators 112 and 122 and the reception radiators 152 and 162 may be about 50 GHz or more, e.g., in a range from 50 GHz to 80 GHz, or from 55 GHz to 77 GHz.

In some embodiments, the first reception antenna unit 150 may include a first reception transmitting line 154 connected to the first reception radiator 152 and a first reception sub-ground 156 disposed around the first reception transmitting line 154.

For example, an antenna unit of substantially the same structure and material as the first transmission antenna unit 110 may be provided as the first reception antenna unit 150.

For example, descriptions of the first transmission transmitting line 114, the first transmission sub-ground 116, the first transmission signal pad 118 and the first transmission ground pad 119 may be equally applied to the first reception transmitting line 154, the first reception sub-ground 156, the first reception signal pad 158 and the first reception ground pad 159, respectively.

In some embodiments, a spacing distance D1 between neighboring first reception radiators among the plurality of the first reception radiators 152 may be greater than or equal to 80% of the half-wavelength (22) of the maximum resonance frequency.

For example, the spacing distance D1 between neighboring first reception radiators among the plurality of the first reception radiators 152 may be 90% or more, 95% or 100% or more of the half-wavelength (Ξ/2) of the maximum resonance frequency.

For example, the spacing distance D1 between neighboring first reception radiators among the plurality of the first reception radiators 152 may be 150% or less, 120% or less, or 110% or less of the half-wavelength (22) of the maximum resonance frequency.

For example, the spacing distance D1 between neighboring first reception radiators among the plurality of the first reception radiators 152 may be in a range from 80% to 150% of the half-wavelength (Ξ/2) of the maximum resonance frequency.

In one embodiment, the spacing distance D1 between neighboring first reception radiators among the plurality of the first reception radiators 152 may be the half-wavelength (λ/2) of the maximum resonance frequency.

In some embodiments, a spacing distance D2 between the second reception radiator 162 and the first reception radiator 152 adjacent to the second reception radiator 162 may be 80% or more of the half-wavelength (Ξ/2) of the maximum resonance frequency.

For example, the spacing distance D2 between the second reception radiator 162 and the first reception radiator 152 adjacent to the second reception radiator 162 may be 90% or more, 95% or more, or 100% or more of the half-wavelength (Ξ/2) of the maximum resonance frequency.

For example, the spacing distance D2 between the second reception radiator 162 and the first reception radiator 152 adjacent to the second reception radiator 162 may be 150% or less, 120% or less, or 110% or less of the half-wavelength (Ξ/2) of the maximum resonance frequency.

For example, the spacing distance D2 between the second reception radiator 162 and the first reception radiator 152 adjacent to the second reception radiator 162 may be in a range from 80% to 150% of the half-wavelength (22) of the maximum resonance frequency.

In one embodiment, the spacing distance D2 between the second reception radiator 162 and the first reception radiator 152 adjacent to the second reception radiator 162 may be the half-wavelength (Ξ/2) of the maximum resonance frequency.

Within the ranges of the spacing distances D1 and D2, desired radiation properties may be achieved while preventing mutual interference between the first reception antenna unit 150 and the second reception antenna unit 160. Accordingly, signal loss and distortion may be prevented, thereby implementing high sensitivity and accuracy in, e.g., the motion or distance sensing.

In some embodiments, the second reception antenna unit 160 may include a second reception transmitting line 164 connected to the second reception radiator 162 and a second reception sub-ground 166 disposed around the second reception transmitting line 164.

For example, the second reception sub-ground 166 may be disposed to be physically spaced apart from the second reception transmitting line 164. In an embodiment, the second reception sub-ground 166 may extend in parallel with an extending direction of the second reception transmitting line 164.

In an embodiment, a pair of the second reception sub-grounds 166 may be disposed to be spaced apart from each other with the second reception transmitting line 164 interposed therebetween. The second reception sub-ground 126 may be disposed around the second reception transmitting line 164, so that the gain and the beam width of the antenna structure 100 may be improved.

In some embodiments, the second reception antenna unit 160 may include a second reception signal pad 168 connected to one end portion of the second reception transmitting line 164 and a second reception ground pad 169 disposed around the second reception signal pad 168.

For example, the second reception ground pad 169 may be electrically and physically separated from the second reception signal pad 168.

In one embodiment, the second reception antenna unit 160 may include a pair of the second reception ground pads 169 spaced apart from each other with the second reception signal pad 168 interposed therebetween.

For example, the second reception signal pad 168 may be provided as a substantially integral member with the second reception transmitting line 164. For example, a terminal end portion of the second reception transmitting line 164 may serve as the second reception signal pad 168.

In an embodiment, the second reception sub-ground 166 may be formed as a single member integrally connected to the second reception ground pad 169. For example, the second reception sub-ground 166 may extend from the second reception ground pad 169 toward the second reception radiator 162.

In some embodiments, the second reception transmitting line 164 may include a bent portion BP where an extending direction of the second reception transmitting line 164 is changed from the first direction to the second direction or from the second direction to the first direction. Accordingly, a feeding to the second reception radiator 162 may be implemented while disposing the second reception radiator 162 to be spaced apart from the first reception radiator 152 in the second direction. Thus, spatial efficiency of the antenna structure 100 may be improved.

In some embodiments, the transmission antenna unit group and the reception antenna unit group may be disposed at the same layer or at the same level on the dielectric layer 105.

For example, the first transmission transmitting line 114, the second transmission line transmitting 124, the first reception transmitting line 154 and the second reception transmitting line 164 may be placed at the same layer or at the same level as that of the first transmission radiator 112, the second transmission radiator 122, the first reception radiator 152 and the second reception radiator 162 on the dielectric layer 105.

The transmitting lines 114, 124, 154 and 164 may be arranged at the same level as that of the radiators 112, 122, 152 and 162, so that feeding/driving may be performed without a separate coaxial power supply for a signal input/output and a power supply. Thus, for example, an antenna on display (AoD) in which the antenna structure 100 is disposed on a display panel may be implemented.

In some embodiments, the first transmission transmitting line 114, the second transmission transmitting line 124, the first reception transmitting line 154 and the second reception transmitting line 164 may be disposed at a different layer or a different level from that of the first transmission radiator 112, the second transmission radiator 122, the first reception radiator 152 and the second reception radiator 162 on the dielectric layer 105. In this case, the transmitting lines 114, 124, 154 and 164 and the radiators 112, 122, 152, and 162 may be electrically connected to each other through a via.

In example embodiments, the transmission antenna unit group and the reception antenna unit group may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in a combination of at least two therefrom.

For example, the transmission antenna unit group and the reception antenna unit group may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the transmission antenna unit group and the reception antenna unit group may include a transparent conductive oxide such as indium tin oxide (ITO), indium zinc oxide (IZO), indium zinc tin oxide (ITZO), zinc oxide (ZnOx), etc.

In some embodiments, the transmission antenna unit group and the reception antenna unit group may include a stacked structure of a transparent conductive oxide layer and a metal layer, and may include, e.g., a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The transmission antenna unit group and the reception antenna unit group may include a blackened portion, so that a reflectance at a surface of the antenna structure 100 may be decreased to suppress a visual pattern recognition due to a light reflectance.

In an embodiment, a surface of the metal layer included in the transmission antenna unit group and the reception antenna unit group may be converted into a metal oxide or a metal sulfide to form a blackened layer. In an embodiment, a blackened layer such as a black material coating layer or a plating layer may be formed on the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

The radiators 112, 122, 152 and 162 may include a polygonal shape such as a triangle, a square, a rhombus, a pentagon and a hexagon, and may include a circular shape.

FIG. 3 is a schematic plan view illustrating an antenna structure in accordance with exemplary embodiments.

Referring to FIG. 3, a plurality of the first reception antenna units 150 may include three or more first reception antenna units 150. Accordingly, motion recognition performance or radar detection performance may be further improved.

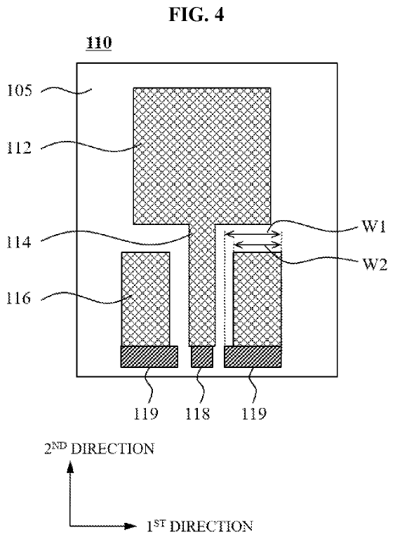

FIG. 4 is a schematic plan view illustrating an antenna unit in accordance with exemplary embodiments.

In FIG. 4, the first transmission antenna unit 110 is illustrated as an example. However, descriptions provided with reference to FIG. 4 may be equally applied to the second transmission antenna unit 120, the first reception antenna unit 150 and the second reception antenna unit 160. For example, a relation between a length W1 of the first transmission ground pad in the first direction and a length W2 of the first transmission sub-ground 116 in the first direction may correspond to a relation between a length of the ground pad in the first direction and a length of the sub-ground in the first direction of each antenna unit.

Referring to FIG. 4, the length W1 of the first transmission ground pad in the first direction may be greater than the length W2 of the first transmission sub-ground 116 in the first direction. Accordingly, a distance between the first transmission sub-ground 116 and the first transmission transmitting line 114 may be sufficiently achieved, thereby preventing signal interference and disturbance.

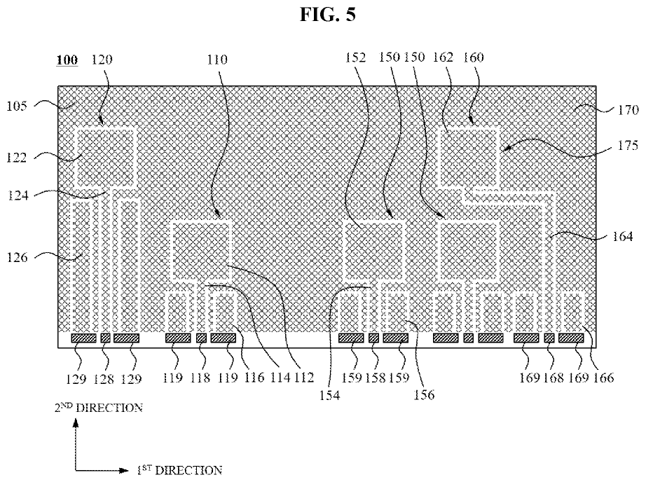

FIG. 5 is a schematic plan view illustrating an antenna structure in accordance with exemplary embodiments.

Referring to FIG. 5, each of the first transmission radiator 112, the second transmission radiator 122, the first reception radiator 152 and the second reception radiator 162 may have a mesh structure. Thus, an optical transmittance of the antenna structure 100 may be improved.

In example embodiments, the radiators 112, 122, 152, 162, transmitting lines 114, 124, 154 and 164 and the sub-grounds 116, 126, 156 and 166 may entirely include the mesh structure.

In an embodiment, at least a portion of the transmitting lines 114, 124, 154 and 164 may include a solid structure for improving driving properties, impedance matching and feeding efficiency of the antenna structure 100. For example, end portions of the transmitting lines 114, 124, 154 and 164 may have a solid structure. In this case, the end portions of the transmitting lines 114, 124, 154 and 164 may be provided as bonding portions with a circuit board.

In some embodiments, when portions of the transmitting lines 114, 124, 154 and 164 have the solid structure, portions of the sub-grounds 116, 126, 156 and 166 may also have the hollow structure.

In some embodiments, the signal pads 118, 128, 158 and 168 and the ground pads 119, 129, 159 and 169 may have the solid structure. For example, the signal pads 118, 128, 158 and 168 and the ground pads 119, 129, 159 and 169 may be provided as bonding portions with the circuit board.

In some embodiments, the antenna structure 100 may further include a dummy mesh pattern 170 disposed around the antenna units 110, 120, 150 and 160. For example, the dummy mesh pattern 170 may be electrically and physically separated from the radiators 112, 122, 152 and 162, the transmitting lines 114, 124, 154 and 164 and the sub-grounds 116, 126, 156 and 166 by a separation region 175.

For example, a conductive layer including the above-described metal or alloy may be formed on the dielectric layer 105. A mesh structure may also be formed when etching the conductive layer along a profile of the antenna units 110, 120, 150 and 160. Accordingly, the dummy mesh pattern 170 spaced apart from the antenna units 110, 120, 150 and 160 may be formed by the separation region 175.

The dummy mesh pattern 170 may be distributed, so that the transmittance of the antenna structure 100 may be improved, and optical properties around the radiators 112, 122, 152 and 162 may become uniform. Thus, the antenna structure 100 and a pattern shape may be prevented from being visually recognized.

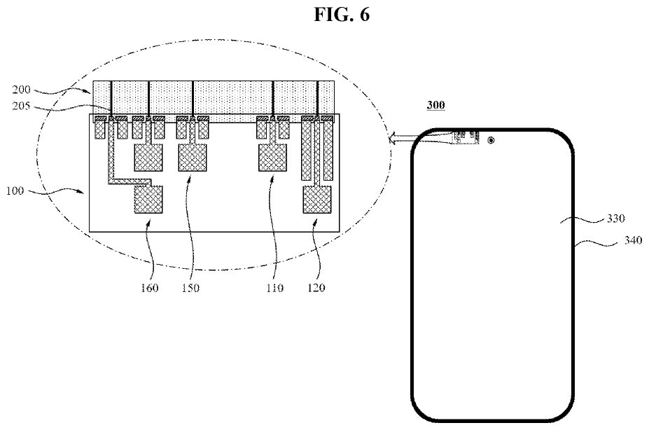

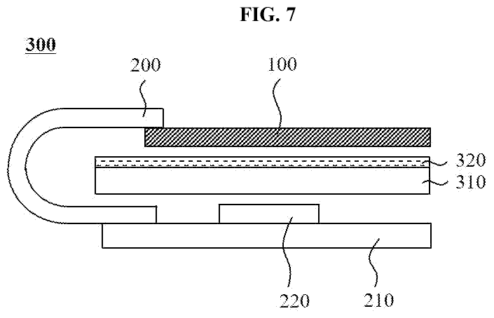

FIGS. 6 and 7 are a schematic plan view and a cross-sectional view, respectively, illustrating an image display device in accordance with example embodiments.

FIG. 6 shows a front portion or a window face of an image display device 300. The front portion of the image display device 300 may include a display area 330 and a non-display area 340. The non-display area 340 may correspond to, e.g., a light-shielding portion or a bezel portion of the image display device 300.

The antenna structure 100 according to exemplary embodiments may be disposed toward the front portion of the image display device 300, and may be disposed on, e.g., a display panel.

In some embodiments, the above-described antenna structure 100 may be attached to the display panel in the form of a film.

In an embodiment, the antenna structure 100 may be formed commonly over the display area 330 and the non-display area 340 of the image display device 300. In an embodiment, the radiators 112, 122, 152 and 162 may be at least partially disposed on the display area 330.

As described above, portions of the transmitting lines 114, 124, 154 and 164 having the solid structure, so that the signal pads 118, 128, 158 and 168 and the ground pads 119, 129, 159 and 169 may overlap the non-display area 340. For example, portions of the antenna units 110, 120, 150 and 160 having the solid structure may overlap the non-display area 340.

In some embodiments, the antenna structure 100 may be located at a central portion of one side of the image display device 300. Accordingly, the motion detection performance on any side may be prevented from being deteriorated, and a motion or an action of the sensing object may be detected in all directions on the front portion of the image display device 300.

Feeding or driving of the antenna structure 100 may be implemented through a circuit board 200.

In some embodiments, one end portions of the transmitting lines 114, 124, 154 and 164 may be connected to the radiators 112, 122, 152 and 162, and the other end portions of the transmitting lines 114, 124, 154 and 164 may be bonded to the circuit board 200.

The circuit board 200 may include, e.g., a flexible printed circuit board (FPCB). For example, a conductive bonding structure such as an anisotropic conductive film (ACF) may be bonded onto the other end portions of the transmitting lines 114, 124, 154 and 164, and then the circuit board 200 may be heat-pressed on the conductive bonding structure.

The circuit board 200 may include a circuit wiring 205 bonded to the other end portions of the transmitting lines 114, 124, 154 and 164. The circuit wiring 205 may serve as an antenna feeding wiring. For example, one end portion of the circuit wiring 205 may be exposed to an outside, and the exposed one end portion of the circuit wiring 205 may be bonded onto the transmitting lines 114, 124, 154 and 164. Thus, the circuit wiring 205 and the antenna structure 100 may be electrically connected.

An antenna driving IC chip may be mounted on the circuit board 200. In an embodiment, an intermediate circuit board such as a rigid printed circuit board may be disposed between the circuit board 200 and the antenna driving IC chip. In an embodiment, the antenna driving IC chip may be directly mounted on the circuit board 200.

A motion sensor driving circuit may be mounted on the circuit board 200. For example, the antenna structure 100 and the circuit board 200 may be electrically connected, so that signal transmission/reception information of the antenna structure 100 may be transmitted to the motion sensor driving circuit. Therefore, a motion recognition sensor including the antenna structure 100 may be provided.

Referring to FIG. 7, the image display device 300 may include a display panel 310 and the above-described antenna structure 100 disposed on the display panel 310.

In example embodiments, an optical layer 320 may be further included on the display panel 310. For example, the optical layer 320 may be a polarizing layer including a polarizer or a polarizing plate.

In an embodiment, a cover window may be disposed on the antenna structure 100. The cover window may include, e.g., glass (e.g., ultra-thin glass (UTG)) or a transparent resin film. Accordingly, an external impact applied to the antenna structure 100 may be reduced or alleviated.

For example, the antenna structure 100 may be disposed between the optical layer 320 and the cover window. In this case, the optical layer 320 may serve as an antenna dielectric layer of the radiators 112, 122, 152 and 162 together with the dielectric layer 105. Accordingly, an appropriate dielectric constant may be achieved, and thus the motion sensing performance of the antenna structure 100 may be sufficiently achieved.

For example, the optical layer 320 and the antenna structure 100 may be stacked by a first adhesive layer, and the antenna structure 100 and the cover window may be stacked by a second adhesive layer.

The circuit board 200 (e.g., the flexible printed circuit board) may be bent along a lateral bending profile of the display panel 310 and disposed at a rear portion of the image display device 300 to extend toward an intermediate circuit board 210 (e.g., a main board) on which the driving IC chip is mounted.

The circuit board 200 and the intermediate circuit board 210 may be bonded or interconnected through a connector, so that the feeding to the antenna structure 100 and antenna driving control may be performed by an antenna driving IC chip.

In some embodiments, a motion sensor driving circuit 220 may be mounted on the intermediate circuit board 210. In an embodiment, the motion sensor driving circuit 220 may include a proximity sensor, a gesture sensor, an acceleration sensor, a gyroscope sensor, a position sensor, a magnetic sensor, etc.

In some embodiments, the radiators 112, 122, 152 and 162 may be coupled to the motion sensor driving circuit 220.

In an embodiment, the antenna structure 100 may be electrically connected to the motion sensor driving circuit 220 through the flexible circuit board 200 that may be bonded or interconnected to the intermediate circuit board 210. Thus, the signal intensity change in the first direction and the second direction of the antenna structure 100 may be transmitted/provided to the motion sensor driving circuit 220.

In an embodiment, signal intensities of the first reception radiator 152, the second reception radiator 162 and the virtual radiator VR according to the movement of the sensing object from a specific first position to a specific second position may be measured, so that the action of the sensing object may be measured by. For example, the motion sensor driving circuit 220 coupled to the antenna structure 100 may detect the action by measuring the signal intensity change between the first reception radiators 152, the signal intensity change between the first reception radiator 152 and the second reception radiator 162, the signal intensity change between the virtual radiators VR, and the signal intensity change between the first reception radiator 152 and virtual radiator VR, and the signal intensity change between the second reception radiator 162 and the virtual radiator VR corresponding to a movement from the first position to the second position,

For example, the movement of the sensing target in the first direction may be detected by a plurality of the first reception radiators 152 and/or the virtual radiators VR. For example, a movement of the sensing target in the second direction may be detected by the first reception radiator 152, the second reception radiator 162 and/or the virtual radiator VR. Therefore, the signal intensity change according to the action operation/position on two axes perpendicular to each other may be provided from the antenna structure 100 to the motion sensor driving circuit 220. The motion sensor driving circuit 220 may measure the action, the motion and the distance according to each axis.

For example, the formation of the virtual radiators VR may provide more accurate measurement of the signal intensity change, thereby improving the precision of a motion tracking in azimuth and elevation angle directions.

In an embodiment, the motion sensor driving circuit 220 may include a motion detection circuit. Signal information transmitted from the antenna structure 100 may be converted/calculated into a location information or a distance information through the motion detection circuit.

In an embodiment, the antenna structure 100 may be electrically connected to a radar sensor circuit. Accordingly, the signal transmission/reception information may be transmitted to the radar processor. For example, the antenna structure 100 may be electrically connected to a radar processor through the circuit board 200 and the intermediate circuit board 210. Thus, a radar sensor including the antenna structure 100 may be provided.

The radar sensor may detect information on the sensing object by analyzing a transmission signal and a reception signal. For example, the antenna structure 100 may measure a distance to the sensing object by transmitting the transmission signal and receiving the reception signal reflected by the sensing object.

For example, the distance to the sensing object may be calculated by measuring a time required for the signal transmitted from the antenna structure 100 to be reflected on the sensing object and received back to the antenna structure 100.

What is claimed is:

1. An antenna structure comprising:
a transmission antenna unit group; and
a reception antenna unit group spaced apart from the transmission antenna unit group in a first direction,
wherein the transmission antenna unit group comprises:
a first transmission antenna unit; and
a second transmission antenna unit having a length in a second direction greater than a length of the first transmission antenna unit in the second direction, the second direction being perpendicular to the first direction, wherein the reception antenna unit group comprises:
a first reception antenna unit spaced apart from the first transmission antenna unit in the first direction, the first reception antenna unit comprising a first reception radiator; and
a second reception antenna unit comprising a second reception radiator spaced apart the first reception radiator in the second direction.

2. The antenna structure according to claim 1, wherein the second transmission antenna unit is spaced apart from the reception antenna unit group in the first direction with the first transmission antenna unit interposed therebetween.

3. The antenna structure according to claim 1, wherein the first transmission antenna unit comprises a first transmission radiator, a first transmission transmitting line connected to the first transmission radiator, and a first transmission sub- ground disposed around the first transmission transmitting line, and
the second transmission antenna unit comprises a second transmission radiator, a second transmission transmitting line connected to the second transmission radiator, and a second transmission sub-ground disposed around the second transmission transmitting line.

4. The antenna structure according to claim 3, wherein a spacing distance between the first transmission radiator and the second transmission radiator in the first direction is in a range from 80% to 150% of a half-wavelength (λ/2) of a maximum resonance frequency, and
a spacing distance between the first transmission radiator and the second transmission radiator in the second direction is in a range from 80% to 150% of the half-wavelength (λ/2) of the maximum resonance frequency.

5. The antenna structure according to claim 3, wherein a length of the second transmission transmitting line in the second direction is greater than a length of the first transmission transmitting line in the second direction.

6. The antenna structure according to claim 3, wherein a length of the second transmission sub-ground in the second direction is greater than a length of the first transmission sub-ground in the second direction.

7. The antenna structure according to claim 3, wherein the first transmission antenna unit further comprises a first transmission signal pad connected to one end portion of the first transmission transmitting line, and a first transmission ground pad disposed around the first transmission signal pad, and
the second transmission antenna unit further comprises a second transmission signal pad connected to one end portion of the second transmission transmitting line, and a second transmission ground pad disposed around the second transmission signal pad.

8. The antenna structure according to claim 7, wherein a length of the first transmission sub-ground in the first direction is smaller than a length of the first transmission ground pad in the first direction.

9. The antenna structure according to claim 1, wherein the first reception antenna unit comprises a plurality of first reception antenna units arranged in a row along the first direction, and
the second reception radiator is spaced apart from the first reception radiator included in at least one of the plurality of first reception antenna units in the second direction.

10. The antenna structure according to claim 9, wherein the second reception radiator is spaced apart from the first reception radiator included in a first reception antenna unit farthest from the first transmission antenna unit among the plurality of first reception antenna units to face the first reception radiator in the second direction.

11. The antenna structure according to claim 9, wherein a spacing distance between adjacent first reception radiators among the first reception radiators included in the plurality of first reception antenna units is in a range from 80% to 150% of a half-wavelength (λ/2) of a maximum resonance frequency.

12. The antenna structure according to claim 1, wherein a spacing distance between the second reception radiator and the first reception radiator adjacent to the second reception radiator is in a range from 80% to 150% of a half-wavelength (Ξ/2) of a maximum resonance frequency.

13. The antenna structure according to claim 1, wherein the first reception antenna unit further comprises a first reception transmitting line connected to the first reception radiator and a first reception sub-ground disposed around the first reception transmitting line, and the second reception antenna unit further comprises a second reception transmitting line connected to the second reception radiator and a second reception sub-ground disposed around the second reception transmitting line.

14. The antenna structure according to claim 13, wherein the second reception transmitting line comprises a bent portion where an extension direction of the second reception transmitting line is changed from the first direction to the second direction or from the second direction to the first direction.

15. The antenna structure according to claim 13, wherein the first reception antenna unit further comprises a first reception signal pad connected to one end portion of the first reception transmitting line, and a first reception ground pad disposed around the first reception signal pad, and the second reception antenna unit further comprises a second reception signal pad connected to one end portion of the second reception transmitting line, and a second reception ground pad disposed around the second reception signal pad.

16. The antenna structure according to claim 1, further comprising a dielectric layer on which the transmission antenna unit group and the reception antenna unit group are disposed, wherein the transmission antenna unit group and the reception antenna unit group are disposed at the same level on the dielectric layer.

17. A motion recognition sensor comprising the antenna structure according to claim 1.

18. A radar sensor comprising the antenna structure according to claim 1.

19. An image display device, comprising:
a display panel; and
the antenna structure according to claim 1 disposed on the display panel.
